(19) United States
(12) Patent Application Publication
(10) Pub. No.: US 2014/0253425 A1
(43) Pub. Date: Sep. 11, 2014

(54) METHOD AND APPARATUS FOR DRIVING ELECTRO-OPTIC DISPLAYS

(71) Applicant: E Ink corporation, Billerica, MA (US)

(72) Inventors: Jonathan L. Zalesky, Newton, MA (US); Ning Liu, Shrewsbury, MA (US)

(21) Appl. No.: 14/200,710

(22) Filed: Mar. 7, 2014

Related U.S. Application Data
(60) Provisional application No. 61/774,230, filed on Mar. 7, 2013.

(51) Int. Cl. G09G 3/34

(52) U.S. Cl. CPC G09G 3/344
USPC 345/107

(57) ABSTRACT

An electro-optic display module (100) comprises an electro-optic medium, electrodes, and a controller (106) having outputs each connected to one electrode. A voltage supply (110) under the control of the controller and connected to a power input of the controller, supplies to a power input of the controller either an operating voltage, or a non-operating voltage lower than the operating voltage. The display module has a display operating mode, in which the voltage supply supplies the operating voltage to the controller and the controller applies the operating voltage to at least one electrode, and a display non-operating mode, in which the voltage supply supplies the non-operating voltage to the controller and the controller does not apply this non-operating voltage to any of the electrodes.

### REFERENCE TO RELATED APPLICATIONS

This application claims benefit of copending provisional Application Ser. No. 61/774,230, filed Mar. 7, 2013.

This application is related to U.S. Pat. Nos. 5,930,026; 6,445,489; 6,504,524; 6,512,354; 6,531,997; 6,753,999; 6,825,970; 6,900,851; 6,995,550; 7,012,600***; 7,023,420; 7,034,783; 7,116,466; 7,119,772; 7,193,625; 7,202,847; 7,259,744; 7,304,787; 7,312,794; 7,327,511; 7,453,445;*** 7,492,339; 7,528,822; 7,545,358; 7,583,251; 7,602,374; 7,612,760; 7,679,599; 7,688,297; 7,729,039; 7,733,311; 7,733,335; 7,787,169; 7,952,557; 7,956,841; 7,999,787; 8,077,141; 8,125,501; 8,139,050; 8,174,490; 8,289,250; 8,300,006; and 8,314,784; and U.S. Patent Applications Publication Nos. 2003/0102858; 2005/0122284; 2005/0179642; 2005/0253777; 2007/0091418; 2007/0103427; 2008/0024429; 2008/0024482; 2008/0136774; 2008/0150888; 2008/0291129; 2009/0174651; 2009/0179923; 2009/0195568; 2009/0322721; 2010/0045592; 2010/0220121; 2010/0220122; 2010/0265561; 2011/0187684; 2011/0193840; 2011/0193841; 2011/0199671; 2011/0285754; and 2013/0194250; and copending application Ser. No. 14/152,067, filed Jan. 10, 2014.

The aforementioned patents and applications may hereinafter for convenience collectively be referred to as the “MEDEOD” (MEthods for Driving Electro-Optic Displays) applications. The entire contents of these patents and copending applications, and of all other U.S. patents and published and copending applications mentioned below, are herein incorporated by reference.

### BACKGROUND OF INVENTION

The present invention relates to a method and apparatus for driving electro-optic displays, especially bistable electro-optic displays. This invention is especially, but not exclusively, intended for use with particle-based electrophoretic displays in which one or more types of electrically charged particles are present in a fluid and are moved through the fluid under the influence of an electric field to change the appearance of the display.

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The term “gray state” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display, and should be understood as normally including extreme optical states which are not strictly black and white, for example the aforementioned white and dark blue states. The term “monochrome” may be used hereinafter to denote a drive scheme which only drives pixels to their two extreme optical states with no intervening gray states.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

The term “impulse” is used herein in its conventional meaning of the integral of voltage with respect to time. However, some bistable electro-optic media act as charge transducers, and with such media an alternative definition of impulse, namely the integral of current over time (which is equal to the total charge applied) may be used. The appropriate definition of impulse should be used, depending on whether the medium acts as a voltage-time impulse transducer or a charge impulse transducer.

Much of the discussion below will focus on methods for driving one or more pixels of an electro-optic display through a transition from an initial gray level to a final gray level (which may or may not be different from the initial gray level). The term “waveform” will be used to denote the entire voltage against time curve used to effect the transition from one specific initial gray level to a specific final gray level. Typically such a waveform will comprise a plurality of waveform elements; where these elements are essentially rectangular (i.e., where a given element comprises application of a constant voltage for a period of time); the elements may be called “pulses” or “drive pulses”. The term “drive scheme” denotes a set of waveforms sufficient to effect all possible transitions between gray levels for a specific display. A display may make use of more than one drive scheme; for example, the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible, as described in several of the aforementioned MEDEOD applications, to use more than one drive scheme simultaneously in different areas of the same display, and a set of drive schemes used in this manner may be referred to as “a set of simultaneous drive schemes.”

Several types of electro-optic displays are known. One type of electro-optic display is a rotating bichromal member type as described, for example, in U.S. Pat. Nos. 5,808,783; 5,777,782; 5,760,761; 6,054,071 6,055,091; 6,097,531; 6,128,124; 6,137,467; and 6,147,791 (although this type of display is often referred to as a “rotating bichromal ball” display, the term “rotating bichromal member” is preferred as more accurate since in some of the patents mentioned above the rotating members are not spherical). Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

Another type of electro-optic display uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. Nos. 6,301,038; 6,870,657; and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in the these patents and applications include:
(a) Electrophoretic particles, fluids and fluid additives; see for example U.S. Pat. Nos. 7,002,728; and 7,679,814;
(b) Capsules, binders and encapsulation processes; see for example U.S. Pat. Nos. 6,922,276; and 7,411,719;
(c) Films and sub-assemblies containing electro-optic materials; see for example U.S. Pat. Nos. 6,982,178; and 7,839,564;
(d) Backplanes, adhesive layers and other auxiliary layers and methods used in displays; see for example U.S. Pat. Nos. 7,116,318; and 7,535,624;
(e) Color formation and color adjustment; see for example U.S. Pat. No. 7,075,502; and U.S. Patent Application Publication No. 2007/0109219;
(f) Methods for driving displays; see the aforementioned MEDEOD applications;
(g) Applications of displays; see for example U.S. Pat. Nos. 7,312,784; and 8,009,348; and
(h) Non-electrophoretic displays, as described in U.S. Pat. Nos. 6,241,921; 6,950,220; 7,420,549 and 8,319,759; and U.S. Patent Application Publication No. 2012/0293858.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449, both assigned to Sipix Imaging, Inc.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

Other types of electro-optic media may also be used in the displays of the present invention.

The bistable or multi-stable behavior of particle-based electrophoretic displays, and other electro-optic displays displaying similar behavior (such displays may hereinafter for convenience be referred to as “impulse driven displays”), is in marked contrast to that of conventional liquid crystal (“LC”) displays. Twisted nematic liquid crystals are not bi- or multi-stable but act as voltage transducers, so that applying a given electric field to a pixel of such a display produces a specific gray level at the pixel, regardless of the gray level previously present at the pixel. Furthermore, LC displays are only driven in one direction (from non-transmissive or “dark” to transmissive or “light”), the reverse transition from a lighter state to a darker one being effected by reducing or eliminating the electric field. Finally, the gray level of a pixel of an LC display is not sensitive to the polarity of the electric field, only to its magnitude, and indeed for technical reasons commercial LC displays usually reverse the polarity of the driving field at frequent intervals. In contrast, bistable electro-optic displays act, to a first approximation, as impulse transducers, so that the final state of a pixel depends not only upon the electric field applied and the time for which this field is applied, but also upon the state of the pixel prior to the application of the electric field.

It has been found that electrophoretic and similar bistable electro-optic displays are well adapted for use as simple, low cost displays which can be used to display outputs from measuring instruments, as point-of-purchase labels and in various types of consumer goods, for example bathroom scales. Such simple, low cost displays are typically of the segmented type, in which the backplane is divided into a number of shaped electrodes (segments), each provided with an associated conductor for controlling the voltage applied to its associated electrode. (More costly displays, such as those used in electronic book readers, are typically of the active matrix type and run at about 15 Volts.) Such a segmented backplane may be arranged to represent a series of digits, each digit being formed from a conventional seven-segment arrangement. More complicated arrangements of segmented electrodes may be used to display letters (including accented letters in non-English alphabets); see, for example, U.S. Design Pat. No. D485294.

To be economically viable, simple, low cost displays require low cost display controllers, preferably of a type which can readily be integrated into a module with the display itself, and although specialist controllers for bistable electrophoretic and similar displays have been developed for use in electronic book readers and similar devices, such specialist controllers are too costly for low cost displays, and are usually adapted for driving active matrix rather than segmented displays. Furthermore, as discussed in the aforementioned MEDEOD applications, the drive schemes needed to drive bistable electro-optic displays are often rather complicated because the bistable nature of the electro-optic medium requires considerable of both the initial and final states of each transition, not merely the final state as in liquid crystal displays. Also, power consumption is crucial in low cost electro-optic displays since such displays are often battery powered and need to have long working lifetimes on a single battery charge. Accordingly, at present there are no off-the-shelf electronics solutions for driving low cost segmented bistable displays.

It has recently been found that simple segmented displays can provide satisfactory electro-optic performance at a driving voltage of about 5 Volts, which enables a wider variety of low cost, off-the-shelf electronics to be used in driving such displays, as compared with the electronics required to drive 15 Volt displays. On attractive solution to providing a low cost display module is use a microcontroller having general purpose input/output pins (GPIOs) running at 5 Volts to drive the segmented display directly. However, many customer application electronics normally run at lower voltages, for example 3.3 Volts or even lower. To boost the voltage outputs of such electronics to provide the 5 Volts needed to drive a display module, a charge pump is needed; such charge pumps are readily available commercially but add cost to the display module.

Many commercial microcontrollers are able to operate over a wide range of voltages, for example 1.8-5.0 Volts. With an appropriate power supply means, such a microcontroller can be used to control an electro-optic display, with the power supply supplying a operating voltage to the microcontroller when this microcontroller is driving the display, and a lower non-operating voltage to the microcontroller when the microcontroller is not driving the display.

### SUMMARY OF INVENTION

Accordingly, in one aspect, this invention provides an electro-optic display module comprising an electro-optic medium and a plurality of electrodes disposed adjacent the electro-optic medium and arranged to apply an electric field thereto. The module further comprises a controller having a plurality of outputs each connected to one of the plurality of electrodes, and voltage supply means connected to a power input of the controller. The voltage supply means can supply to the power input of the controller either an operating voltage or a non-operating voltage lower than the operating voltage. The voltage supply means is under the control of the controller. The display module has two modes, a display operating mode in which the voltage supply means supplies the operating voltage to the controller and the controller applies the operating voltage to at least one of the plurality of electrodes, and a display non-operating mode, in which the voltage supply means supplies the non-operating voltage to the controller and the controller does not apply this non-operating voltage to any of the plurality of electrodes.

In one form of the electro-optic display module of the present invention, the controller comprises at least one of a pulse width modulation timer (PWM) and a voltage comparator. Such a pulse width modulation timer and/or voltage comparator can be used with a small set of discrete components to create a voltage supply means (a charge-pump power supply) able to supply operating and non-operating voltages to the controller and regulated by the microcontroller itself When the controller needs to drive the display, it would use the PWM timer to operate the charge-pump and the comparator and a reference voltage to detect when the proper operating voltage (5 Volts) has been reached and to regulate the PWM output. The controller would then apply the 5 Volts to those display electrodes connected to its GPIOs as needed to update the display. At the end of the display update, the controller would turn off the charge-pump system, and the voltage would decay back to the pass-through non-operating voltage.

The display module of the present invention may make use of any of the type of electro-optic media discussed above. Thus, for example, the display module may comprise a rotating bichromal member or electrochromic material. Alternatively, the display module may comprise an electrophoretic material comprising a plurality of electrically charged particles disposed in a fluid and capable of moving through the fluid under the influence of an electric field. The electrically charged particles and the fluid may be confined within a plurality of capsules or microcells. Alternatively, the electrically charged particles and the fluid may be present as a plurality of discrete droplets surrounded by a continuous phase comprising a polymeric material. The fluid may be liquid or gaseous.

### BRIEF DESCRIPTION OF THE DRAWINGS

FIG. 1 of the accompanying drawings is a block diagram of a segmented display module of the present invention.

FIG. 2 is a circuit diagram illustrating one example of discrete components connected to a microcontroller and serving as the charge pump shown in FIG. 1.

### DETAILED DESCRIPTION

As explained above, the present invention provides an electro-optic display module comprising an electro-optic medium and a plurality of electrodes disposed adjacent the electro-optic medium and arranged to apply an electric field thereto. The module further comprises a controller having a plurality of outputs each connected to one of the plurality of electrodes, and voltage supply means connected to a power input of the controller. The voltage supply means can supply to the power input of the controller either an operating voltage or a non-operating voltage lower than the operating voltage. The voltage supply means is under the control of the controller. The display module has two modes, a display operating mode in which the voltage supply means supplies the operating voltage to the controller and the controller applies the operating voltage to at least one of the plurality of electrodes, and a display non-operating mode, in which the voltage supply means supplies the non-operating voltage to the controller and the controller does not apply this non-operating voltage to any of the plurality of electrodes.

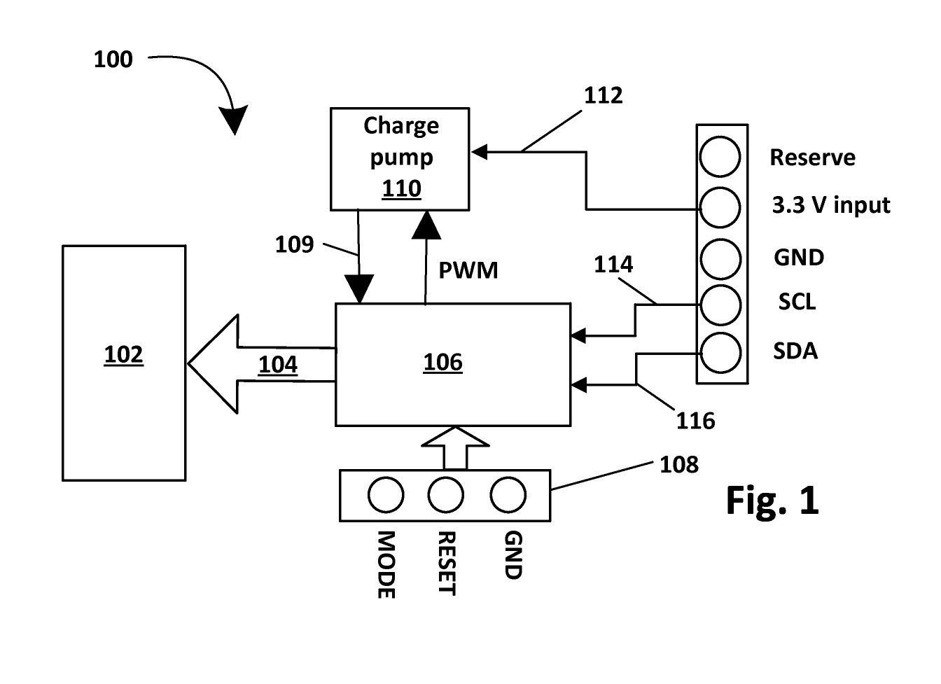

FIG. 1 is a block diagram of one segmented display module of the present invention (generally designated 100). This display module comprises an electro-optic section 102 comprising an electro-optic medium (not shown) and a plurality of segmented electrodes (also not shown) arranged to apply electric fields to the electro-optic medium to change the optical state thereof. Each electrode is provided with a separate conductor, which runs via a bus (104) to one of the general purpose input/outputs (GPIOs) of a controller 106, which may be a Renesas Electronics Corporation R8C/38C or R8C/3GG microcontroller (available from Renesas Electronics America Inc., 2880 Scott Boulevard, Santa Clara Calif. 95050). The microcontroller receives inputs from a manually operable programming pad 108 having GND, Reset and Mode buttons, and receives a voltage input of 3.3 or 5 Volts on line 109, from a charge pump 110, which itself receives an input from a pulse width modulation (PWM) output of the controller 106. The charge pump receives 3.3 Volt from an input line 112, and also receives SCL and SDA inputs 114 and 116 respectively as shown in FIG. 1.

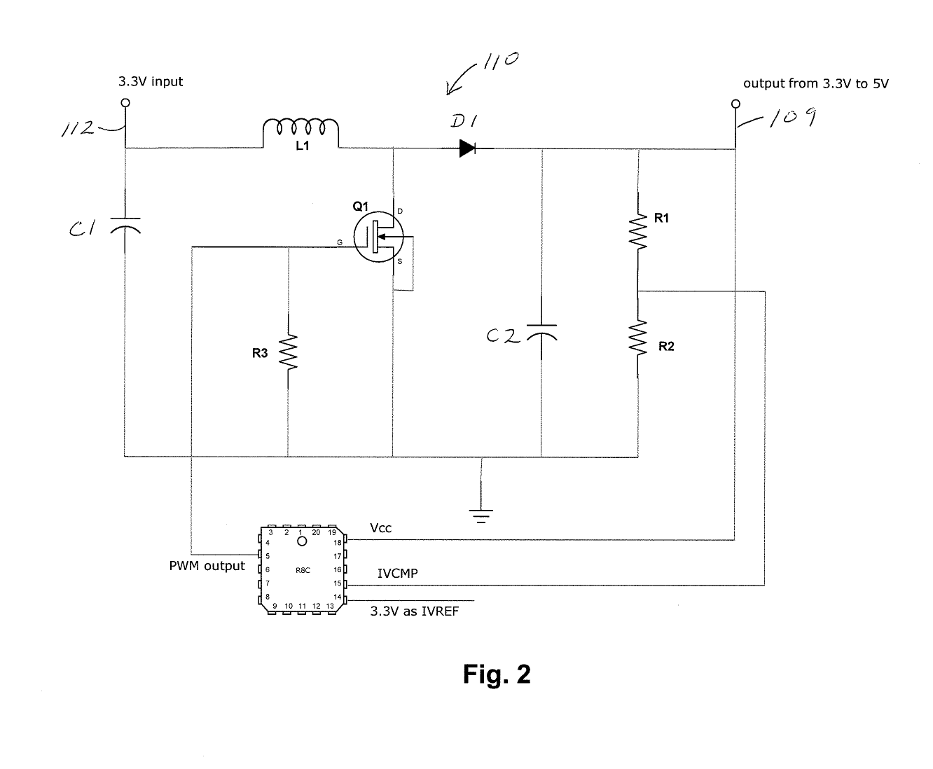

FIG. 2 is a circuit diagram showing the circuitry of the charge pump 110 shown in FIG. 1, together with the interconnections between the charge pump 110 and the controller. As shown in FIG. 2, the 3.3 V input 112 is connected to one side of a capacitor C1, the opposed side of which is connected to ground. The input 112 is also connected via inductor L1 and diode D1 to the variable output 109, which is fed to the Vcc input (pin 18) of controller 106. The output of diode D1 is also connected to ground via an RC circuit comprising capacitor C2 in parallel with series resistors R1 and R2. The voltage between resistors R1 and R2 is fed to the IVCMP input (pin 15) of controller 106. The IVREF input (pin 14) of controller 106 receives the same 3.3 V input as input 112.

A transistor Q1 has its drain connected to the conductor connecting inductor L1 and diode D1. The source of transistor Q1 is connected to ground, while its gate receives the PWM output from pin 5 of controller 106. The gate of Q1 is also connected to ground via resistor R3. It is believed that the operation of the charge pump will readily be apparent from FIG. 2.

From the foregoing description, it will be seen that the present invention provides a simple, low cost controller for driving electro-optic display modules. In the display non-operating mode, the controller can operate at the lower non-operating voltage, thus reducing power consumption and potentially increasing battery life. A charge pump of the type shown in FIG. 2 uses a small number of discrete components and will typically be of lower cost than an integrated charge pump circuit. Customers' electronics can communicate to the microcontroller how to update the display while the microcontroller is running at its lower non-operating voltage, thus eliminating the need for additional voltage level conversion circuitry for the input/output interface.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. An electro-optic display module comprising:
an electro-optic medium;
a plurality of electrodes disposed adjacent the electro-optic medium and arranged to apply an electric field thereto;
a controller having a plurality of outputs each connected to one of the plurality of electrodes; and
voltage supply means under the control of the controller and connected to a power input of the controller, and arranged to supply to the power input of the controller either an operating voltage, or a non-operating voltage lower than the operating voltage,
the display module having a display operating mode, in which the voltage supply means supplies the operating voltage to the controller and the controller applies the operating voltage to at least one of the plurality of electrodes, and a display non-operating mode, in which the voltage supply means supplies the non-operating voltage to the controller and the controller does not apply this non-operating voltage to any of the plurality of electrodes.

2. An electro-optic display module according to claim 1 wherein the controller comprises at least one of a pulse width modulation timer and a voltage comparator.

3. An electro-optic display module according to claim 1 wherein each of the plurality of electrodes is electrically connected to a separate conductor, and each of the plurality of conductors is connected to a separate output on the controller.

4. An electro-optic display module according to claim 1 wherein the electro-optic medium comprises a rotating bichromal member medium or electrochromic medium.

5. An electro-optic display module according to claim 1 wherein the electro-optic medium comprises an electrophoretic material comprising a plurality of electrically charged particles disposed in a fluid and capable of moving through the fluid under the influence of an electric field.

6. An electro-optic display module according to claim 5 wherein the electrically charged particles and the fluid are confined within a plurality of capsules or microcells.

7. An electro-optic display module according to claim 5 wherein the electrically charged particles and the fluid are present as a plurality of discrete droplets surrounded by a continuous phase comprising a polymeric material.

8. An electro-optic display module according to claim 5 wherein the fluid is gaseous.

9. An electronic book reader, portable computer, tablet computer, cellular telephone, smart card, sign, watch, shelf label, variable transmission window or flash drive comprising a display module according to claim 1
